(19) United States
(12) Patent Application Publication
(10) Pub. No.: US 2025/0361665 A1
(43) Pub. Date: Nov. 27, 2025

(54) WASHING MACHINE AND METHOD FOR CONTROLLING THE SAME

(71) Applicant: SAMSUNG ELECTRONICS CO., LTD., Suwon-si (KR)

(72) Inventors: Minwoo RYU, Suwon-si (KR); Taegyu KIM, Suwon-si (KR); Jungwook BAE, Suwon-si (KR)

(73) Assignee: SAMSUNG ELECTRONICS CO., LTD., Suwon-si (KR)

(21) Appl. No.: 19/212,221

(22) Filed: May 19, 2025

Related U.S. Application Data
(63) Continuation of application No. PCT/KR2025/005019, filed on Apr. 14, 2025.

(30) Foreign Application Priority Data
May 23, 2024 (KR) 10-2024-0067399

(51) Int. Cl. D06F 34/18; D06F 23/02; D06F 23/04; D06F 33/36; D06F 34/28; D06F 39/08; D06F 103/04; D06F 103/06; D06F 103/08; D06F 103/18; D06F 103/46; D06F 105/52; D06F 105/58; G05B 13/02

(52) U.S. Cl. CPC D06F 34/18; D06F 23/02; D06F 23/04; D06F 33/36; D06F 34/28; D06F 39/087; G05B 13/0265; D06F 2103/04; D06F 2103/06; D06F 2103/08; D06F 2103/18; D06F 2103/46; D06F 2105/52; D06F 2105/58

(57) ABSTRACT

A washing machine may include: a drum configured to accommodate laundry; a motor configured to rotate the drum; a current sensor configured to detect a current value corresponding to a current applied to the motor; and at least one processor configured to: identify a first current value corresponding to a current value detected by the current sensor while the motor rotates the drum with the laundry in a dry state, identify a second current value corresponding to a current value detected by the current sensor while the motor rotates the drum with the laundry in a wet state, determine a moisture content ratio of the laundry based on an amount of water in the laundry and a weight of the laundry, and input the detected first current value, the detected second current value and the determined moisture content ratio into an artificial intelligence (AI) model to identify a material of the laundry.

This is a continuation application, under 35 U.S.C. § 111 (a), of International Application No. PCT/KR2025/005019, filed Apr. 14, 2025, which claims priority under 35 U.S.C. § 119 to Korean Patent Application No. 10-2024-0067399, filed May 23, 2024, in the Korean Intellectual Property Office, the disclosures of which are incorporated herein in their entireties by reference.

### TECHNICAL FIELD

The disclosure relates to a washing machine that may detect a material of laundry, and a method for controlling the same.

### BACKGROUND ART

In general, a washing machine includes a tub and a drum which is rotatably installed inside the tub. Laundry may be washed by rotating the drum containing the laundry inside the tub. The washing machine may perform a washing process for washing laundry, a rinsing process for rinsing washed laundry, and a spin-drying process for spin-drying laundry.

In order to wash laundry efficiently without damage, an appropriate washing process is to be performed for each type of fabric (laundry material) by identifying the fabric type of the laundry.

### DISCLOSURE

### Technical Solution

The disclosure provides a washing machine and a method for controlling the same that may identify various laundry materials more accurately.

The disclosure provides a washing machine and a method for controlling the same that may perform an efficient washing process by changing wash settings according to laundry materials.

The disclosure provides a washing machine and a method for controlling the same that may calculate a moisture content ratio of laundry using only a flow sensor and a water level sensor without any additional sensor.

Technical aspects that can be achieved by the disclosure are not limited to the above-mentioned aspects, and other technical aspects not mentioned will be clearly understood by one of ordinary skill in the technical art to which the disclosure belongs from the following description.

In accordance with the present disclosure, a washing machine may include: a drum configured to accommodate laundry; a motor configured to rotate the drum; a current sensor configured to detect a current value corresponding to a current applied to the motor; and at least one processor configured to: identify a first current value corresponding to a current value detected by the current sensor while the motor rotates the drum with the laundry in a dry state, identify a second current value corresponding to a current value detected by the current sensor while the motor rotates the drum with the laundry in a wet state, determine a moisture content ratio of the laundry based on an amount of water in the laundry and a weight of the laundry, and input the detected first current value, the detected second current value and the determined moisture content ratio into an artificial intelligence (AI) model to identify a material of the laundry.

The washing machine may further comprising: a flow sensor configured to detect an amount of water supplied to the drum; and a water level sensor configured to detect a water level of water in the drum, wherein the at least one processor is further configured to: determine the amount of water in the laundry based on the amount of water supplied to the drum detected by the flow sensor and the water level of water in the drum detected by the water level sensor.

The at least one processor is further configured to: determine a first amount of water in the drum based on the amount of water supplied to the drum detected by the flow sensor, determine a second amount of water in the drum based on the water level of water in the drum detected by the water level sensor, and determine the moisture content ratio of the laundry based on a difference between the first amount of water and the second amount of water.

The at least one processor is further configured to: determine the first amount of water in the drum based on the amount of water supplied to the drum detected by the flow sensor according to a flow rate/water level correlation formula stored in a memory.

The at least one processor is further configured to: change a wash setting of the washing machine based on the identified material of the laundry

The at least one processor is further configured to: start a washing process according to a default wash setting based on receiving a washing start command, and perform an operation to identify the material of the laundry in response to an elapse of a predetermined period of time after the washing process is started.

The at least one processor is further configured to: change the washing process to a washing process corresponding to the identified material of the laundry in response to the material of the laundry being identified.

The washing machine may further comprising: a user interface, wherein the at least one processor is further configured to: control the user interface to provide an interface related to changing of the wash setting of the washing machine.

The AI model is trained based on data associated with materials of laundry, current values corresponding to a current applied to the motor, and moisture content ratios of laundry.

The detected first current value includes an average of current values detected by the current sensor and which correspond to currents applied to the motor while the motor rotates the drum with the laundry in the dry state, and the detected second current value includes an average and a variance of current values detected by the current sensor and which correspond to currents applied to the motor while the motor rotates the drum with the laundry in the wet state.

In accordance with the present disclosure, a method for controlling a washing machine including a drum configured to accommodate laundry, a motor configured to rotate the drum, and a current sensor configured to detect a current value corresponding to a current applied to the motor, the method comprising: identifying a first current value corresponding to a current value detected by the current sensor while the motor rotates the drum with the laundry in a dry state, identifying a second current value corresponding to a current value detected by the current sensor while the motor rotates the drum with the laundry in a wet state, determining a moisture content ratio of the laundry based on an amount of water in the laundry and a weight of the laundry, and inputting the detected first current value, the detected second current value, and the determined moisture content ratio into an artificial intelligence (AI) model to identify a material of the laundry.

The washing machine further includes: a flow sensor configured to detect an amount of water supplied to the drum, and a water level sensor configured to detect a water level of water in the drum, and wherein the determining the moisture content ratio of the laundry includes determining the amount of water in the laundry based on the amount of water supplied to the drum detected by the flow sensor and the water level of water in the drum detected by the water level sensor.

The determining the moisture content ratio of the laundry includes: determining a first amount of water in the drum based on the amount of water supplied to the drum detected by the flow sensor, determining a second amount of water in the drum based on the water level of water in the drum detected by the water level sensor, and determining the moisture content ratio of the laundry based on a difference between the first amount of water and the second amount of water.

The determining of the first amount of water in the drum includes determining the first amount of water in the drum based on the amount of water supplied to the drum detected by the flow sensor according to a flow rate/water level correlation formula stored in a memory.

The method may further comprising: changing a wash setting of the washing machine based on the identified material of the laundry.

### DESCRIPTION OF DRAWINGS

FIG. 1 is a view illustrating an example of an exterior of a washing machine according to an embodiment.

FIG. 2 is a cross-sectional view of the washing machine shown in FIG. 1.

FIG. 3 is a view illustrating an example of an exterior of a washing machine according to an embodiment.

FIG. 4 is a cross-sectional view of the washing machine shown in FIG. 3.

FIG. 5 is a control block diagram of a washing machine according to an embodiment.

FIG. 6 is a flowchart illustrating a method for controlling a washing machine according to an embodiment.

FIG. 7 is a diagram illustrating identification of laundry material based on a plurality of parameter values according to an embodiment.

FIG. 8 is a diagram illustrating classification of laundry material for each input factor by using a trained model of a washing machine according to an embodiment.

FIG. 9 is a diagram illustrating classification of laundry material in a case where an average current value in a dry state of laundry, an average current value in a wet state of laundry, a variance of current values in a wet state of laundry, and a moisture content ratio are input into a trained model of a washing machine according to an embodiment.

FIG. 10 is a flowchart illustrating a process of calculating a moisture content ratio of laundry according to an embodiment.

FIG. 11 is a diagram illustrating a correlation between flow rate and water level according to an embodiment.

FIG. 12 is a flowchart illustrating operations after identification of laundry material according to an embodiment.

FIG. 13 is a diagram illustrating an interface related to change of wash settings according to laundry material identification according to an embodiment.

### MODES OF THE DISCLOSURE

Various embodiments of the disclosure and terms used herein are not intended to limit the technical features described herein to specific embodiments, and should be understood to include various modifications, equivalents, or substitutions of the corresponding embodiments.

In describing of the drawings, similar reference numerals may be used for similar or related elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

As used herein, the term “and/or” includes any and all combinations of one or more of the associated listed items.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

A washing machine according to various embodiments may perform washing, rinsing, spin-drying, and drying processes. The washing machine is an example of a clothes treating apparatus, and the clothes treating apparatus is a concept including a device capable of washing clothes (objects to be washed, and objects to be dried), a device capable of drying clothes, and a device capable of washing and drying clothes.

The washing machine according to various embodiments may include a top-loading washing machine in which a laundry inlet for inserting or removing laundry is provided to face upward, or a front-loading washing machine in which a laundry inlet is provided to face forward. The washing machine according to various embodiments may include a washing machine of a loading type other than the top-loading washing machine and the front-loading washing machine.

For the top-loading washing machine, laundry may be washed using water current generated by a rotating body such as a pulsator. For the front-loading washing machine, laundry may be washed by repeatedly lifting and lowering laundry by rotating a drum. The front-loading washing machine may include a dryer combined washing machine capable of drying laundry stored in a drum. The dryer combined washing machine may include a hot air supply device for supplying high-temperature air into the drum and a condensing device for removing moisture from air discharged from the drum. For example, the dryer combined washing machine may include a heat pump device. The washing machine according to various embodiments may include a washing machine using a washing method other than the above-described washing method.

The washing machine according to various embodiments may include a housing accommodating various components therein. The housing may be provided in the form of a box including a laundry inlet on one side thereof.

The washing machine may include a door for opening and closing the laundry inlet. The door may be rotatably mounted to the housing by a hinge. At least a portion of the door may be transparent or translucent to allow the inside of the housing to be visible.

The washing machine may include a tub disposed within the housing to store water. The tub may be formed in a substantially cylindrical shape with a tub opening formed on one side thereof. The tub may be disposed inside the housing in such a way that the tub opening corresponds to the laundry inlet.

The tub may be connected to the housing by a damper. The damper may absorb vibration generated when the drum rotates, and the damper may reduce vibration transmitted to the housing.

The washing machine may include a drum provided to accommodate laundry.

The drum may be disposed inside the tub such that a drum opening provided on one side of the drum corresponds to the laundry inlet and the tub opening. Laundry may pass sequentially through the laundry inlet, the tub opening, and the drum opening and then be received in the drum or removed from the drum.

The drum may perform each operation according to washing, rinsing, and/or spin-drying while rotating in the tub. A plurality of through holes may be formed in a cylindrical wall of the drum to allow water stored in the tub to be introduced into or to be discharged from the drum.

The washing machine may include a driving device configured to rotate the drum. The driving device may include a drive motor and a rotating shaft for transmitting a driving force generated by the drive motor to the drum. The rotating shaft may penetrate the tub to be connected to the drum.

The driving device may perform respective operations according to washing, rinsing, and/or spin-drying, or drying processes by rotating the drum in a forward or reverse direction.

The washing machine may include a water supply device configured to supply water to the tub. The water supply device may include a water supply pipe and a water supply valve disposed in the water supply pipe. The water supply pipe may be connected to an external water supply source. The water supply pipe may extend from an external water supply source to a detergent supply device and/or the tub. Water may be supplied to the tub through the detergent supply device. Alternatively, water may be supplied to the tub without passing through the detergent supply device.

The water supply valve may open or close the water supply pipe in response to an electrical signal from a controller. The water supply valve may allow or block the supply of water to the tub from an external water supply source. The water supply valve may include a solenoid valve configured to open or close in response to an electrical signal.

The washing machine may include the detergent supply device configured to supply detergent to the tub. The detergent supply device may include a manual detergent supply device that requires a user to enter detergent to be used for each washing, and an automatic detergent supply device that stores a large amount of detergent and automatically adds a predetermined amount of detergent during washing. The detergent supply device may include a detergent container for storing detergent. The detergent supply device may be configured to supply detergent into the tub during a water supply process. Water supplied through the water supply pipe may be mixed with detergent via the detergent supply device. Water mixed with detergent may be supplied into the tub. Detergent is used as a term including detergent for pre-washing, detergent for main washing, fabric softener, bleach, etc., and the detergent container may be partitioned into a storage region for the pre-washing detergent, a storage region for the main washing detergent, a storage region for the fabric softener, and a storage region for the bleach.

The washing machine may include a drainage device configured to discharge water contained in the tub to the outside. The drainage device may include a drain pipe extending from a bottom of the tub to the outside of the housing, a drain valve disposed on the drain pipe to open or close the drain pipe, and a pump disposed on the drain pipe. The pump may pump water from the drain pipe to the outside of the housing.

The washing machine may include a control panel disposed on one side of the housing. The control panel may provide a user interface for interaction between a user and the washing machine. The user interface may include at least one input interface and at least one output interface.

The at least one input interface may convert sensory information received from a user into an electrical signal.

The at least one input interface may include a power button, an operation button, a course selection dial (or a course selection button), and washing/rinsing/spin-drying setting buttons. The at least one input interface may include a tact switch, a push switch, a slide switch, a toggle switch, a micro switch, a touch switch, a touch pad, a touch screen, a jog dial, and/or a microphone.

The at least one output interface may visually or audibly transmit information related to the operation of the washing machine to a user.

For example, the at least one output interface may transmit information related to a washing course, operation time of the washing machine, and washing/rinsing/spin-drying settings to the user. Information about the operation of the washing machine may be output via a screen, an indicator, or a voice. The at least one output interface may include a liquid crystal display (LCD) panel, a light emitting diode (LED) panel, or a speaker.

The washing machine may include a communication module for wired and/or wireless communication with an external device.

The communication module may include at least one of a short-range wireless communication module and a long-range wireless communication module.

The communication module may transmit data to an external device (e.g., a server, a user device, and/or a home appliance) or receive data from the external device. For example, the communication module may establish communication with a server and/or a user device and/or a home appliance, and transmit and receive various types of data.

For the communication, the communication module may establish a direct (e.g., wired) communication channel or a wireless communication channel between the external devices, and support the performance of the communication through the established communication channel. According to an embodiment, the communication module may include a wireless communication module (e.g., a cellular communication module, a short-range wireless communication module, or a global navigation satellite system (GNSS) communication module) or a wired communication module (e.g., a local area network (LAN) communication module, or a power line communication module). Among these communication modules, the corresponding communication module may communicate with an external device through a first network (e.g., a short-range wireless communication network such as Bluetooth, wireless fidelity (Wi-Fi) direct, or infrared data association (IrDA)) or a second network (e.g., a long-range wireless communication network such as a legacy cellular network, a 5G network, a next-generation communication network, the Internet, or a computer network (e.g., LAN or wide area network WAN)). These various types of communication modules may be integrated as a single component (e.g., a single chip) or implemented as a plurality of separate components (e.g., multiple chips).

The short-range wireless communication module may include a Bluetooth communication module, a Bluetooth Low Energy (BLE) communication module, a near field communication module, a WLAN (Wi-Fi) communication module, and a Zigbee communication module, an IrDA communication module, a Wi-Fi Direct (WFD) communication module, an ultrawideband (UWB) communication module, an Ant+communication module, a microwave (uWave) communication module, etc., but is not limited thereto.

The long-range wireless communication module may include a communication module that performs various types of long-range wireless communication, and may include a mobile communication circuitry. The mobile communication circuitry transmits and receives radio signals with at least one of a base station, an external terminal, and a server in a mobile communication network.

According to an embodiment, the communication module may communicate with an external device such as a server, a user device and other home appliances through an access point (AP). The AP may connect a LAN, to which a washing machine or a user device is connected, to a WAN to which a server is connected. The washing machine or the user device may be connected to the server via the WAN. The controller may control various components of the washing machine (e.g., the drive motor, and the water supply valve). The controller may control various components of the washing machine to perform at least one operation including water supply, washing, rinsing, and/or spin-drying according to a user input. For example, the controller may control the drive motor to adjust the rotational speed of the drum or control the water supply valve of the water supply device to supply water to the tub.

The controller may include hardware such as a CPU or memory, and software such as a control program. For example, the controller may include at least one memory for storing an algorithm and program-type data for controlling the operation of components in the washing machine, and at least one processor configured to perform the above-mentioned operation by using the data stored in the at least one memory. The memory and the processor may each be implemented as separate chips. The processor may include one or more processor chips or may include one or more processing cores. The memory may include one or more memory chips or one or more memory blocks. Alternatively, the memory and the processor may be implemented as a single chip.

Hereinafter, the washing machine according to various embodiments of the disclosure will be described in detail with reference to the accompanying drawings.

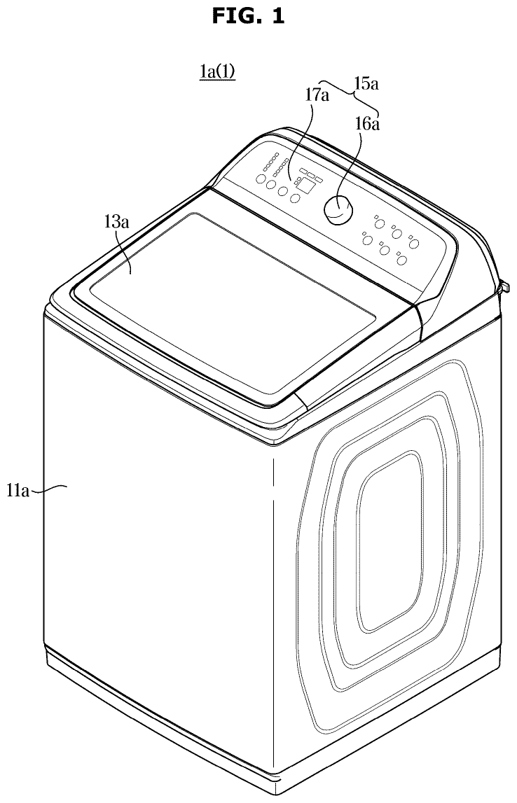

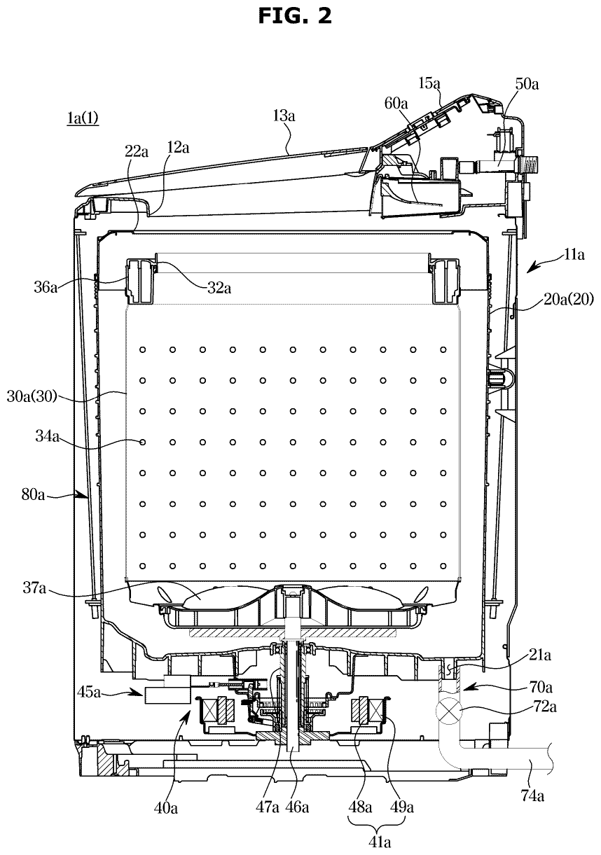

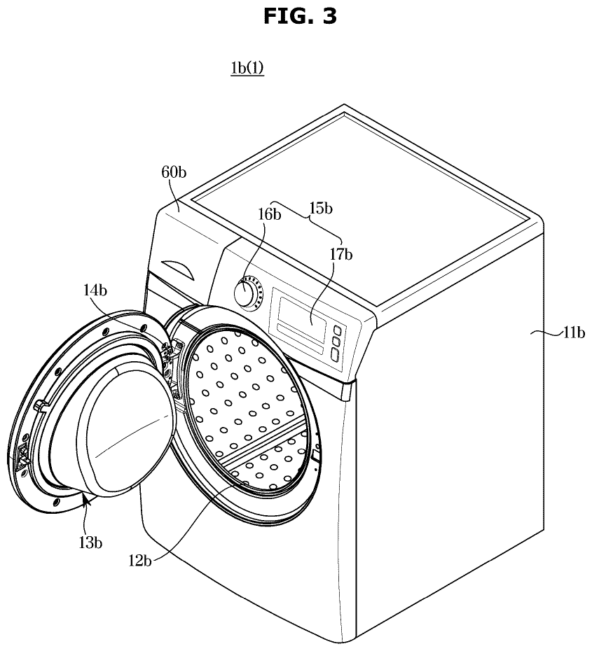

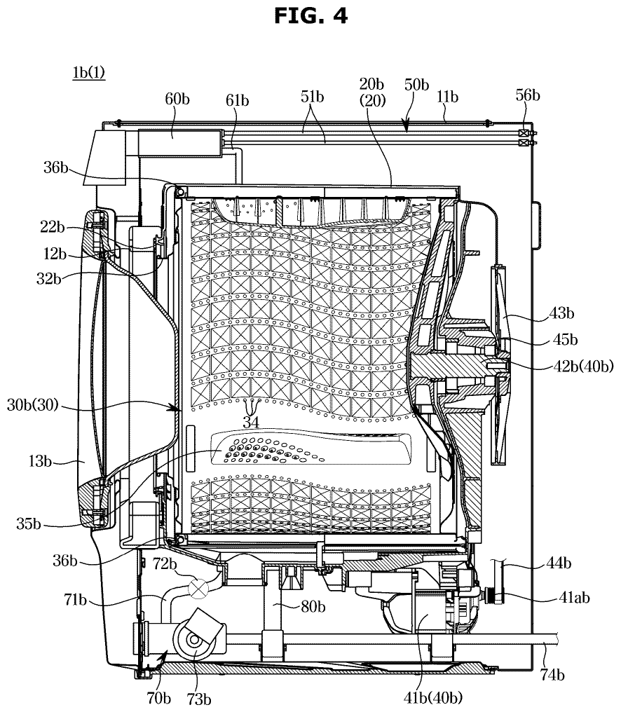

A washing machine 1 according to an embodiment may be a top-loading washing machine 1a (see FIG. 1 and FIG. 2) or a front-loading washing machine 1b (see FIG. 3 and FIG. 4).

FIG. 1 is a view illustrating an example of an exterior of a washing machine according to an embodiment. FIG. 2 is a cross-sectional view of the washing machine shown in FIG. 1.

Referring to FIG. 1 and FIG. 2, the washing machine 1a may include a housing 11a accommodating various components. The housing 11a may form an external appearance of the washing machine 1a. The housing 11a may have a box shape with a partially open portion.

The housing 11a may include a housing opening 12a formed to allow access to the inside of a drum 30a. The housing opening 12a may be open toward approximately the upper side.

The washing machine 1a may include a door 13a for opening and closing the housing opening 12a provided in the housing 11a. The door 13a may be rotatably mounted on the housing 11a by a hinge. At least a portion of the door 13a may be formed of a transparent or semi-transparent material to allow the inside of the housing 11a to be visible.

The washing machine 1a may include a tub 20a inside the housing 11a to store water. The tub 20a may be disposed in the housing 11a. The tub 20a may include a tub opening 22a formed to correspond to the housing opening 12a. The tub opening 22a may be open toward approximately the upper side. The tub 20a may be supported inside the housing 11a. The tub 20a may have a substantially cylindrical shape with one side open.

The tub 20a may be elastically supported by the housing 11a via a damper 80a. The damper 80a may connect the housing 11a and the tub 20a. In a case where vibration generated during rotation of the drum 30a is transmitted to the tub 20a and/or the housing 11a, the damper 80a may absorb vibrational energy between the tub 20a and the housing 11a to attenuate the vibration.

The washing machine 1a may include the drum 30a for accommodating laundry. The drum 30a may be rotatable inside the tub 20a. The drum 30a may perform washing, rinsing, and/or spin-drying while rotating inside the tub 20a. The drum 30a may include through-holes 34a that connect an internal space of the drum 30a and an internal space of the tub 20a. The drum 30a may have a substantially cylindrical shape with one side open.

A balancing unit 36a may be installed on the upper side of the drum 30a to eliminate any load imbalance caused by the laundry. The balancing unit 36a may include a balancer housing having an annular channel and a mass (such as a ball or fluid) movably provided inside the channel. As the drum 30a rotates, the ball or the fluid may move to eliminate the load imbalance of the drum 30a. A ball provided inside the balancer housing is referred to as a ball balancer, and a fluid provided inside the balancer housing is referred to as a fluid balancer.

The balancer housing may be mounted on the drum 30a, and at least one ball balancer or a fluid balancer may be provided therein.

A pulsator 37a may be rotatable on the lower side of the drum 30a to generate a flow of washing water. The laundry may be washed by the washing water flow generated by the pulsator 37a.

The drum 30a may include a drum opening 32a formed to correspond to the housing opening 12a and the tub opening 22a. Laundry may be put into or taken out of the drum 30a through the housing opening 12a, the tub opening 22a, and the drum opening 32a.

The washing machine 1a may include a washing machine driving device 40a for rotating the drum 30a and the pulsator 37a. The washing machine driving device 40a may include a motor 41a, and a shaft system for transmitting driving force generated by the motor 41a to the drum 30a and the pulsator 37a.

The motor 41a may include a stator 48a, which is fixed, and a rotor 49a, which electromagnetically interacts with the stator 48a to rotate.

The shaft system may include a spin-drying shaft 47a to transmit the driving force of the motor 41a to the drum 30a, a washing shaft 46a to transmit the driving force of the motor 41a to the pulsator 37a, and a clutch device 45a to connect or disconnect the motor 41a and the spin-drying shaft 47a.

The spin-drying shaft 47a may be formed with a hollow portion, and the washing shaft 46a may be disposed inside the hollow portion of the spin-drying shaft 47a. The washing shaft 46a may remain connected to the rotor 49a of the motor 41a, and the spin-drying shaft 47a may be connected to or disconnected from the rotor 49a of the motor 41a by the clutch device 45a.

When the clutch device 45a disconnects the spin-drying shaft 47a from the motor 41a, only the washing shaft 46a receives the driving force, and thus only the pulsator 37a rotates. When the clutch device 45a connects the spin-drying shaft 47a to the motor 41a, both the spin-drying shaft 47a and the washing shaft 46a receive the driving force, and thus the drum 30a and the pulsator 37a rotate simultaneously.

In a case where only the pulsator 37a rotates, the pulsator 37a generates a washing water flow, and the laundry rotates within the drum 30a due to the washing water flow and rubs against the drum 30a for washing. In a case where the pulsator 37a and the drum 30a rotate simultaneously, water in the laundry is separated due to centrifugal force as the laundry rotates inside the drum 30a, and thus the laundry is spin-dried.

The washing machine 1a may include a water supply device 50a. The water supply device 50a may supply water to the tub 20a. The water supply device 50a may be located on an upper side of the tub 20a. The water supply device 50a may include a water supply pipe and a water supply valve installed in the water supply pipe. The water supply pipe may be connected to an external water source and extend from the external water source to a detergent supply device 60a and/or the tub 20a. Water may be supplied to the tub 20a through the detergent supply device 60a or may be supplied to the tub 20a without passing through the detergent supply device 60a.

The water supply valve may open or close the water supply pipe in response to an electrical signal. The water supply valve may allow or block the supply of water from the external water source to the tub 20a. The water supply valve may include, for example, a solenoid valve that opens or closes in response to an electrical signal.

The washing machine 1a may include a detergent supply device 60a for supplying detergent to the tub 20a. The detergent supply device 60a may be configured to supply detergent into the tub 20a during a water supply process. Water supplied through the water supply pipe may pass through the detergent supply device 60a and mix with the detergent. The water mixed with detergent may be supplied into the tub 20a. The detergent may include not only a washing detergent but also a dryer softener, a deodorant, a sanitizer, an air freshener, and the like.

The washing machine 1a may include a drainage device 70a. The drainage device 70a may discharge water stored in the tub 20a to the outside. A drain 21a for draining water from the tub 20a may be formed at a lower portion of the tub 20a. A drain hose 74a may be connected to the drain 21a, and a drain valve 72a for opening or closing the drain hose 74a may be installed in the drain hose 74a.

The washing machine 1a may provide a user interface 15a for interaction between a user and the washing machine 1a.

The washing machine 1a may include at least one user interface 15a. The user interface 15a may include at least one input interface 16a and at least one output interface 17a.

The at least one input interface 16a may convert sensory information received from a user into an electrical signal.

The at least one input interface 16a may include a power button, an operation button, a course selection dial (or course selection button), and washing/rinsing/spin-drying setting buttons. The at least one input interface 16a may include, for example, a tact switch, a push switch, a slide switch, a toggle switch, a micro switch, a touch switch, a touch pad, a touch screen, a jog dial, and/or a microphone.

The at least one output interface 17a may generate sensory information to deliver various types of information about operations of the washing machine 1a to the user.

For example, the at least one output interface 17a may deliver information related to a washing course, operation time of the washing machine 1a, and washing/rinsing/spin-drying settings to the user. Information about operations of the washing machine 1a may be output via a screen, an indicator, or voice. The at least one output interface 17a may include, for example, an LCD panel, an LED panel, a speaker, and the like.

FIG. 3 is a view illustrating an example of an exterior of a washing machine according to an embodiment. FIG. 4 is a cross-sectional view of the washing machine shown in FIG. 3.

Referring to FIG. 3 and FIG. 4, the washing machine 1b may include a washing machine housing 11b accommodating various components inside. The washing machine housing 11b may form an external appearance of the washing machine 1b. The washing machine housing 11b may have a box shape with a partially open portion.

The washing machine housing 11b may include a housing opening 12b formed to allow access to the inside of a drum 30b. The housing opening 12b may be open toward approximately the front side.

The washing machine 1b may include a door 13b for opening and closing the housing opening 12b provided in the washing machine housing 11b. The door 13b may be rotatably mounted on the washing machine housing 11b by a hinge 14b. At least a portion of the door 13b may be formed of a transparent or semi-transparent material to allow the inside of the washing machine housing 11b to be visible.

The washing machine 1b may include a tub 20b inside the washing machine housing 11b to store water. The tub 20b may be disposed in the washing machine housing 11b. The tub 20b may include a tub opening 22b formed to correspond to the housing opening 12b. The tub opening 22b may be open toward approximately the front side. The tub 20b may be supported inside the washing machine housing 11b. The tub 20b may have a substantially cylindrical shape with one side open.

The tub 20b may be elastically supported by the washing machine housing 11b via a damper 80b. The damper 80b may connect the washing machine housing 11b and the tub 20b. In a case where vibration generated during rotation of the drum 30b is transmitted to the tub 20b and/or the washing machine housing 11b, the damper 80b may absorb vibrational energy between the tub 20b and the washing machine housing 11b to attenuate the vibration.

The washing machine 1b may include the drum 30b for accommodating laundry. The drum 30b may be rotatable inside the tub 20b. The drum 30b may perform washing, rinsing, and/or spin-drying while rotating inside the tub 20b. The drum 30b may include through-holes 34b that connect an internal space of the drum 30b and an internal space of the tub 20b. The drum 30b may have a substantially cylindrical shape with one side open. At least one lifter 35b may be provided on an inner circumferential surface of the drum 30b to allow laundry to be lifted and dropped during rotation of the drum 30b.

A balancing unit 36b may be installed on one side (e.g., the front side) of the drum 30b to eliminate any load imbalance caused by the laundry. The balancing unit 36b may include a balancer housing having an annular channel and a mass (such as a ball or fluid) movably provided inside the channel. As the drum 30b rotates, the ball or the fluid may move to eliminate the load imbalance of the drum 30b. A ball provided inside the balancer housing is referred to as a ball balancer, and a fluid provided inside the balancer housing is referred to as a fluid balancer.

The balancer housing may be mounted on the drum 30b, and at least one ball balancer or a fluid balancer may be provided therein.

The drum 30b may include a drum opening 32b formed to correspond to the housing opening 12b and the tub opening 22b. Laundry may be put into or taken out of the drum 30b through the housing opening 12b, the tub opening 22b, and the drum opening 32b.

The washing machine 1b may include a washing machine driving device 40b for rotating the drum 30b. The washing machine driving device 40b may include a motor 41b, and a rotary shaft 42b for transmitting driving force generated by the motor 41b to the drum 30b. The rotary shaft 42b may penetrate the tub 20b and be connected to the drum 30b.

The washing machine 1b may be classified into a direct driving type in which the rotary shaft 42b is directly connected to the motor 41b to rotate the drum 30b, or an indirect driving type in which a pulley 43b is connected between the motor 41b and the rotary shaft 42b to drive the drum 30b.

The washing machine 1b according to an embodiment may be an indirect driving type, but is not limited thereto, and may also be configured as a direct driving type.

One end of the rotary shaft 42b may be connected to the drum 30b, and the other end may be connected to the pulley 43b in order to receive driving force from the motor 41b. A motor pulley 41ab may be formed on a rotation shaft of the motor 41b. A driving belt 44b may be provided between the motor pulley 41ab and the pulley 43b, and thus the rotary shaft 42b is driven by the driving belt 44b.

A bearing housing 45b may be installed on the rear portion of the tub 20b to rotatably support the rotary shaft 42b. The bearing housing 45b may be formed of an aluminum alloy and may be inserted into the rear portion of the tub 20b during injection molding of the tub 20b.

The washing machine driving device 40b may perform washing, rinsing, and/or spin-drying or drying operations by rotating the drum 30b forward or backward.

The washing machine 1b may include a water supply device 50b. The water supply device 50b may supply water to the tub 20b. The water supply device 50b may be located on an upper side of the tub 20b. The water supply device 50b may include a water supply pipe 51b and a water supply valve 56b installed in the water supply pipe 51b. The water supply pipe 51b may be connected to an external water source. The water supply pipe 51b may extend from the external water source to a detergent supply device 60b and/or the tub 20b. Water may be supplied to the tub 20b through the detergent supply device 60b or without passing through the detergent supply device 60b.

The water supply valve 56b may open or close the water supply pipe 51b in response to an electrical signal. The water supply valve 56b may allow or block the supply of water from the external water source to the tub 20b. The water supply valve 56b may include, for example, a solenoid valve that opens or closes in response to an electrical signal.

The washing machine 1b may include a detergent supply device 60b for supplying detergent to the tub 20b. The detergent supply device 60b may be configured to supply detergent into the tub 20b during a water supply process. Water supplied through the water supply pipe 51b may pass through the detergent supply device 60b and mix with the detergent. The water mixed with detergent may be supplied into the tub 20b. The detergent may include not only a washing detergent but also a dryer softener, a deodorant, a sanitizer, an air freshener, and the like. The detergent supply device 60b may be connected to the tub 20b through a connection pipe 61b.

The washing machine 1b may include a drainage device 70b. The drainage device 70b may discharge water stored in the tub 20b to the outside. The drainage device 70b may include a drain pump 73b for pumping out water from the tub 20b to the outside of the washing machine housing 11b, a connection hose 71b connecting the tub 20b and the drain pump 73b to allow water inside the tub 20b to flow into the drain pump 73b, and a drain hose 74b guiding water pumped by the drain pump 73b to the outside of the washing machine housing 11b. The drainage device 70b may include a drain valve 72b installed in the connection hose 71b to open or close the connection hose 71b.

The washing machine 1b may provide a user interface 15b for interaction between a user and the washing machine 1b.

The washing machine 1b may include at least one user interface 15b. The user interface 15b may include at least one input interface 16b and at least one output interface 17b.

The at least one input interface 16b may convert sensory information received from a user into an electrical signal.

The at least one input interface 16b may include a power button, an operation button, a course selection dial (or a course selection button), and washing/rinsing/spin-drying setting buttons. The at least one input interface 16b may include, for example, a tact switch, a push switch, a slide switch, a toggle switch, a micro switch, a touch switch, a touch pad, a touch screen, a jog dial, and/or a microphone.

The at least one output interface 17b may generate sensory information to deliver various types of information about operations of the washing machine 1b to the user.

For example, the at least one output interface 17b may deliver information related to a washing course, operation time of the washing machine 1b, and washing/rinsing/spin-drying settings to the user. Information about operations of the washing machine 1b may be output via a screen, an indicator, or voice. The at least one output interface 17b may include, for example, an LCD panel, an LED panel, an LED module, a speaker, and the like.

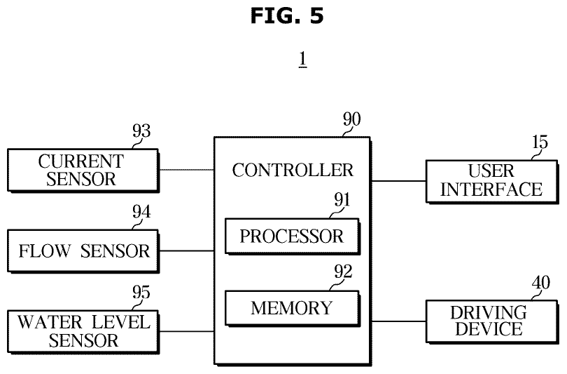

FIG. 5 is a control block diagram of a washing machine according to an embodiment.

According to an embodiment, the washing machine 1 may include the user interface (15; 15a, 15b), the driving device (40; 40a, 40b), a current sensor 93, a flow sensor 94, a water level sensor 95, and/or a controller 90. The controller 90 may include at least one processor 91 and a memory 92.

The user interface 15 may provide an interface for interaction between a user and the washing machine 1.

The user interface 15 may include at least one input interface (16; 16a, 16b) and at least one output interface (17; 17a, 17b).

The at least one input interface 16 may convert sensory information received from a user into an electrical signal.

The at least one input interface 16 may include a power button, an operation button, a course selection dial (or course selection button), and washing/rinsing/spin-drying setting buttons. The at least one input interface 16 may include, for example, a tact switch, a push switch, a slide switch, a toggle switch, a micro switch, a touch switch, a touch pad, a touch screen, a jog dial, and/or a microphone.

The at least one output interface 17 may generate sensory information to deliver various types of information about operations of the washing machine 1 to the user.

For example, the at least one output interface 17 may deliver information related to a washing course, operation time of the washing machine 1, and washing/rinsing/spin-drying settings to the user. Information about operations of the washing machine 1 may be output via a screen, an indicator, or voice. The at least one output interface 17 may include, for example, an LCD panel, an LED panel, a speaker, and the like.

The driving device (40; 40a, 40b) may include the motor (41; 41a, 41b) for providing driving force to rotate the drum (30; 30a, 30b), and a driving circuit 200 for driving the motor 41.

The motor 41 may operate based on a driving current supplied from the driving circuit 200. The driving device 40 may operate based on a control signal from the controller 90.

The washing machine 1 may include at least one sensor for obtaining information about an operating state of the washing machine 1.

As described above, the washing machine 1 may include the current sensor 93 for measuring driving current applied to the motor 41, the flow sensor 94 for measuring the amount of water supplied to the drum 30, and the water level sensor 95 for detecting a water level in the drum 30.

The current sensor 93, the flow sensor 94, and the water level sensor 95 may transmit sensor data to the controller 90.

The controller 90 may include the memory 92 storing control programs and control data for controlling the user interface 15 and the driving device 40, and the at least one processor 91 generating control signals according to the control programs and control data stored in the memory 92. The memory 92 and the processor 91 may be integrally or separately provided.

The memory 92 may store a flow rate/water level correlation formula and a water level/water amount correlation formula to be described later, and may store programs and data for controlling the user interface 15 and the driving device 40.

The memory 92 may include a volatile memory, such as a static random access memory (S-RAM) or a dynamic RAM (D-RAM) for temporarily storing data. In addition, the memory 92 may include a non-volatile memory, such as a read only memory (ROM), an erasable programmable ROM (EPROM), or electrically erasable ROM (EEPROM) for long-term data storage.

In an embodiment, the memory 92 may store an artificial intelligence (AI) model. As described later, the AI model may be trained to identify a material of laundry (hereinafter also referred to as “fabric type”) by using at least one factor obtained by processing sensor data collected from various sensors (e.g., the current sensor 93, the flow sensor 94, and/or the water level sensor 95) of the washing machine 1, together with a moisture content ratio of laundry as input data.

According to various embodiments, the AI model may be stored in a server as well or may be stored only in a server.

The processor 91 may include various logic circuits and arithmetic circuits, process data according to programs provided from the memory 92, and generate control signals based on the processing result.

In a case where a method according to at least one embodiment of the disclosure includes a plurality of operations, the plurality of operations may be performed by one processor or by a plurality of processors. For example, in a case where a first operation, a second operation, and a third operation are performed by the method according to at least one embodiment, the first operation, the second operation, and the third operation may all be performed by one processor, or the first and second operations may be performed by a first processor (e.g., a general-purpose processor) and the third operation may be performed by a second processor (e.g., an AI-dedicated processor).

For example, the controller 90 may be mounted on a printed circuit board provided on the rear side of the user interface 15.

The controller 90 may be electrically connected to the user interface 15, the driving device 40, the current sensor 93, the flow sensor 94, and/or the water level sensor 95.

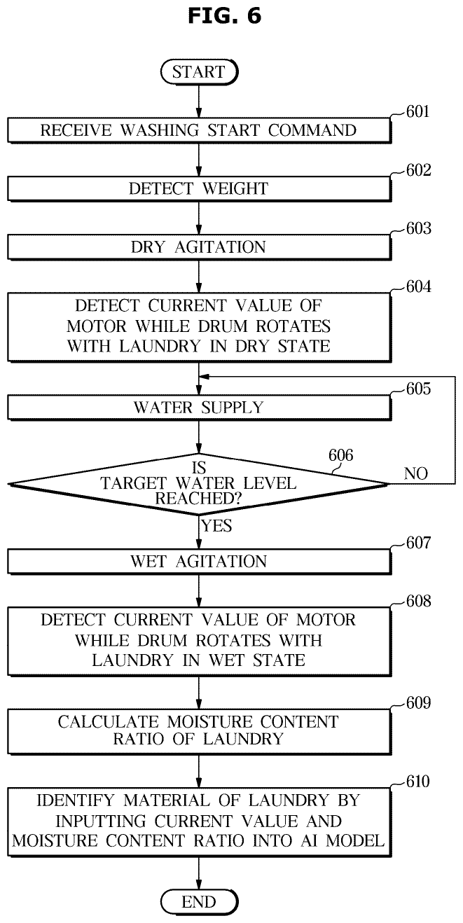

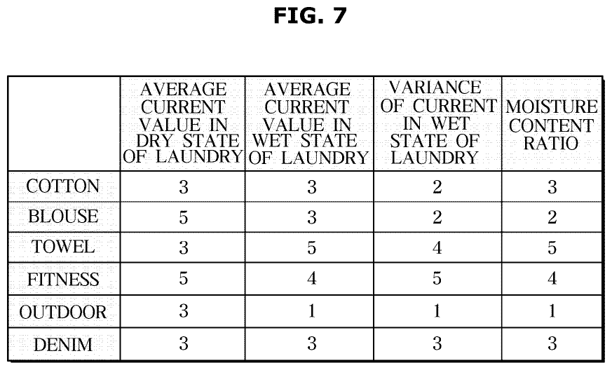

FIG. 6 is a flowchart illustrating a method for controlling a washing machine according to an embodiment. FIG. 7 is a diagram illustrating identification of laundry material based on a plurality of parameter values according to an embodiment.

The processor 91 may receive a washing start command of the washing machine 1 (601).

In an embodiment, the washing machine 1 may provide a plurality of washing courses.

A user may select one washing course from the plurality of washing courses through the user interface 15, and then start the selected washing course.

A material of laundry may be classified as cotton, blouse, towel, fitness, outdoor, denim, mixed, and the like.

The plurality of washing courses may include at least one washing course in which the laundry material is specified and a washing course in which the laundry material is not specified.

The at least one washing course in which the laundry material is specified may include, for example, a “towel washing course,” a “denim washing course,” a “mixed fabric washing course,” etc., where the name of the course itself indicates the fabric type, and may also include any washing course for which a laundry material may be specified.

The washing course in which the laundry material is not specified may include, for example, a general washing course such as a standard washing course and/or an AI washing course, etc.

The processor 91 may detect a weight of laundry accommodated in the drum 30 based on receiving the washing start command (602).

The processor 91 may rotate the drum 30 in a state where laundry has been put into the drum 30 and measure inertia to detect the weight of the laundry. For example, the processor 91 may repeatedly turn the motor 41 on and off. Based on a back electromotive force value generated when the motor 41 is turned off, the processor 91 may measure the weight of the laundry in the drum 30. In addition, the processor 91 may rotate the drum 30 at a preset speed, and measure the time taken to reach the preset speed to measure the weight of the laundry in the drum 30. Further, a separate weight sensor may be used to detect the weight of the laundry.

In a case where the weight of the laundry is less than or equal to a preset weight, the processor 91 may start detecting the laundry material. In a case where the laundry weight exceeds the preset weight, the processor 91 may not start detecting the laundry material.

The processor 91 may perform a dry agitation by rotating the drum 30 in a dry state of the laundry (603). The dry agitation may include rotating the drum 30 to agitate the laundry which is in a dry state.

The processor 91 may obtain a current value (a first current value) detected by the current sensor while the drum 30 rotates with the laundry in a dry state (604).

Here, the first current value may include an average of the current values detected by the current sensor 93 in a dry state of the laundry. That is, the first current value may include an average of current values generated by the motor 41 during agitation of the drum 30 when the laundry is in a dry state.

Here, the first current value may be determined according to Equation 1 below:

$$First current value = {I}_{dry} / Weight \qquad [ Equation 1 ]$$

Here, I_{dry} denotes the current value detected by the current sensor 93 in a dry state of the laundry, and Weight denotes a weight of the laundry detected during the weight detection.

After performing the dry agitation, the processor 91 may supply water (605). The processor 91 may control the water supply valve 56b to allow water to flow into the drum to wet the laundry. In a case where the water in the drum 30 has reached a target water level (Yes in operation 606), the processor 91 may obtain a current value in a wet state of the laundry, which is described below.

Here, the target water level may be set at a level suitable for obtaining the current value of the laundry in a wet state.

After the water supply, the processor 91 may perform a wet agitation by rotating the drum 30 in a wet state of the laundry (607). The processor 91 may obtain a current value (a second current value) detected by the current sensor while the drum 30 rotates with the laundry in a wet state (608).

Here, the second current value may include an average and a variance of current values detected by the current sensor 93 in a wet state of the laundry. That is, the second current value may include an average and a variance of current values generated by the motor 41 during agitation of the drum 30 when the laundry is in a wet state.

Here, the second current value may be determined according to Equation 2 below:

$$Second current value = {I}_{wet} / Weight \qquad [ Equation 2 ]$$

Here, I_{wet} denotes the current value detected by the current sensor 93 in a wet state of the laundry, and Weight denotes a weight of the laundry detected during the weight detection.

The processor 91 may calculate a moisture content ratio of the laundry containing water (609). The moisture content ratio is a factor indicating the amount of water contained per weight of laundry, which may be expressed as “moisture content ratio of laundry=amount of water in laundry/weight of laundry.” A detailed process of calculating the amount of water will be described below.

Thereafter, the processor 91 may identify a material of the laundry by inputting the first current value, the second current value, and the moisture content ratio of the laundry into an AI model (610).

Here, the AI model may be trained to output data about the laundry material by using the first current value, the second current value, and the moisture content ratio as input data.

In an embodiment, the AI model may be stored in the memory 92 and/or an external device (e.g., a server).

In a case where the AI model is stored in the memory 92, the processor 91 may identify the laundry material by inputting the first current value, the second current value, and the moisture content ratio of the laundry into the AI model stored in the memory 92.

In a case where the AI model is stored only in an external device, the processor 91 may transmit information about the first current value, the second current value, and the moisture content ratio to the external device via a communication interface. The external device may input the first current value, the second current value, and the moisture content ratio, received from the washing machine 1, into the AI model, and thus information about the laundry material may be obtained. The external device may then deliver the information about the laundry material to the washing machine 1, and thus the processor 91 may identify the laundry material.

In other words, the operation (610) in which the processor 91 identifies the laundry material by inputting the first current value, the second current value, and the moisture content ratio into the AI model may include an operation in which the processor 91 identifies the laundry material by inputting the first current value, the second current value, and the moisture content ratio into the AI model stored in the memory 92, and/or an operation in which the processor 91 transmits the first current value, the second current value, and the moisture content ratio to an external device storing the AI model via the communication interface and receives information about the laundry material from the external device to identify the laundry material.

Such an AI model may be trained based on data related to the laundry material identified by the AI model using the first current value, the second current value, and the moisture content ratio of the laundry.

Referring to FIG. 7, it may be seen that the laundry material may be identified based on each factor's data value. The data values shown may indicate an exemplary data trend to facilitate understanding of the laundry material.

For example, in a case where the data value identified by the AI model corresponds to 3 for an average current value in a dry state of the laundry, 3 for an average current value in a wet state of the laundry, 2 for a variance of current values in a wet state of the laundry, and 3 for a moisture content ratio, the fabric type (laundry material) of the laundry may be identified as “cotton.”

In addition, in a case where the data value identified by the AI model corresponds to 3 for an average current value in a dry state of the laundry, 5 for an average current value in a wet state of the laundry, 4 for a variance of current values in a wet state of the laundry, and 5 for a moisture content ratio, the laundry's fabric type may be identified as “towel.”

Because the moisture content ratio, which indicates a direct characteristic of the laundry, is included as one of the factors for identifying the material of laundry, a wider variety of fabric types may be detected more accurately. For example, detection accuracy for “denim,” “outdoor,” and “fitness,” which were previously challenging to identify accurately, may be improved, thereby allowing a wider range of identifiable fabric types.

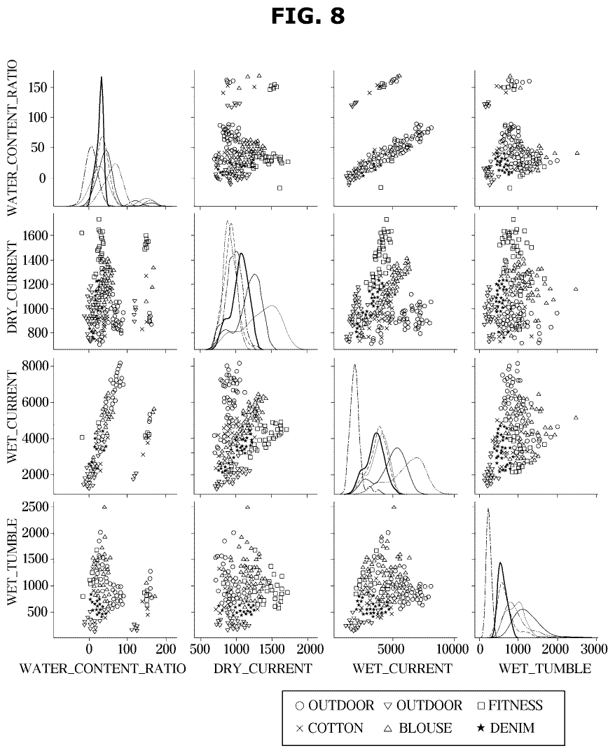

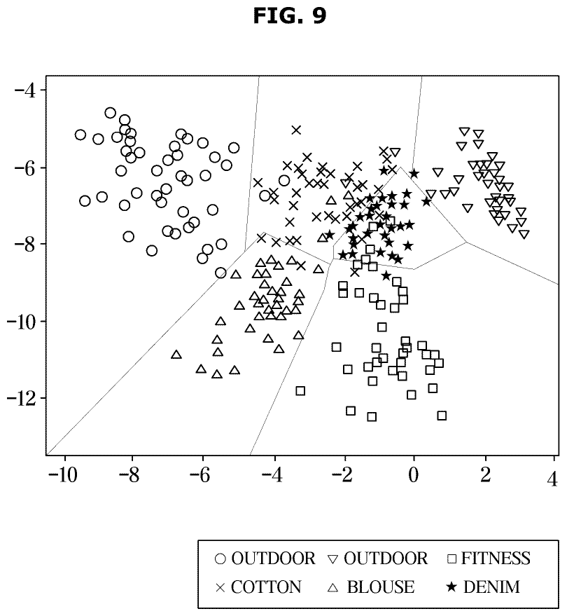

FIG. 8 is a diagram illustrating classification of laundry material for each input factor by using a trained model of a washing machine according to an embodiment. FIG. 9 is a diagram illustrating classification of laundry material in a case where an average current value in a dry state of laundry, an average current value in a wet state of laundry, a variance of current values in a wet state of laundry, and a moisture content ratio are input into a trained model of a washing machine according to an embodiment.

Referring to FIG. 8, examples are shown for cases where a material of laundry is cotton, a blouse (which is a delicate garment), a towel, fitness, outdoor, and denim.

In the case of cotton, blouse, towel, fitness, outdoor, and denim, graphs of a moisture content ratio (WATER_CONTENT_RATIO), an average current value in a dry state (DRY_CURRENT), an average current value in a wet state (WET_CURRENT), and a variance of current in a wet state (WET_TUMBLE) are shown, as well as scatterplots of relationships between two of the above factors.

In other words, the WATER_CONTENT_RATIO, DRY_CURRENT, WET_CURRENT, and WET_TUMBLE for cotton, blouse, towel, fitness, outdoor, and denim are shown.

In addition, relationships between DRY_CURRENT and WET_CURRENT, DRY_CURRENT and WATER_CONTENT_RATIO, and WET_CURRENT and WATER_CONTENT_RATIO for cotton, blouse, towel, fitness, outdoor, and denim are shown.

In a dry state, the blouse and fitness fabrics exhibit the highest average current value (DRY_CURRENT), compared to other fabric types.

In a wet state, the towel exhibits the highest average current value (WATER_CONTENT_RATIO), compared to other fabric types.

Also, the towel has the highest average current value in a wet state (WET_CURRENT) compared to other fabrics, while the fitness fabric has the highest current variance in a wet state (WET_TUMBLE) compared to other fabrics.

Thus, by inputting at least two of the WATER_CONTENT_RATIO, DRY_CURRENT, WET_CURRENT, and WET_TUMBLE into a trained model, the material of the laundry may be classified.

Referring to FIG. 9, the scatterplot for each laundry material is shown according to WATER_CONTENT_RATIO, DRY_CURRENT, WET_CURRENT, and WET_TUMBLE.

By inputting all of WATER_CONTENT_RATIO, DRY_CURRENT, WET_CURRENT, and WET_TUMBLE into the trained model, the material of the laundry may be classified more accurately.

Hereinafter, a process of calculating a moisture content ratio of laundry among the above factors for identifying laundry material is described.

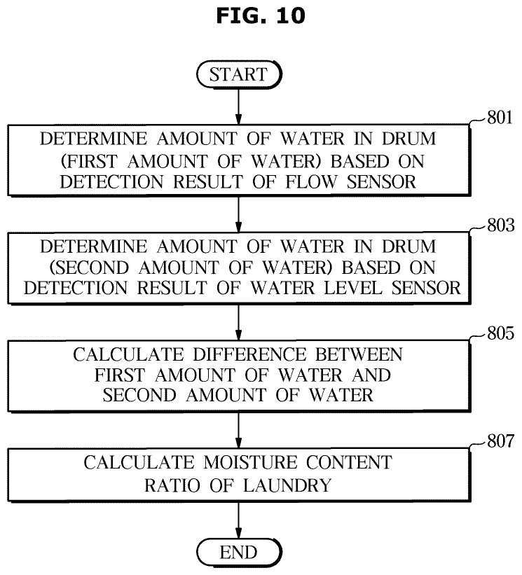

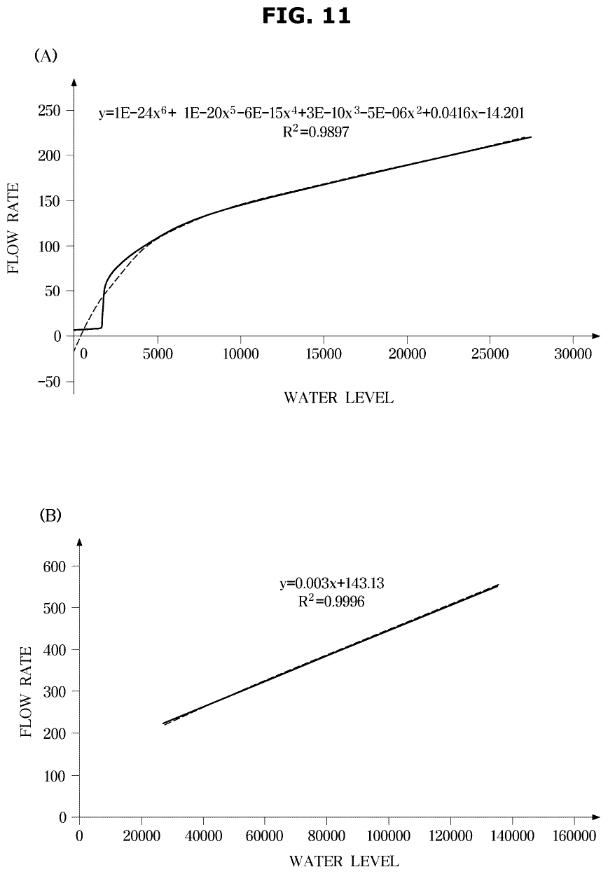

FIG. 10 is a flowchart illustrating a process of calculating a moisture content ratio of laundry according to an embodiment. FIG. 11 is a diagram illustrating a correlation between flow rate and water level according to an embodiment.

As described above, the washing machine 1 may include the flow sensor 94 for measuring the amount of water supplied to the drum 30, and the water level sensor 95 for detecting a water level in the drum 30.

The processor 91 may calculate a moisture content ratio of laundry based on a detection result of the flow sensor 94 and a detection result of the water level sensor 95.

Specifically, the processor 91 may determine the amount of water in the drum (a first amount of water) based on the detection result of the flow sensor 94 (801).

That is, the amount of water contained in the drum 30 may be predicted based on the flow rate detected by the flow sensor 94.

The processor 91 may use a flow rate/water level correlation formula and/or a water level/water amount correlation formula to calculate the amount of water from the detected flow rate.

The above correlation formulas may be stored in the memory 92.

As shown in FIG. 11, the correlation formula between flow rate and water level may be stored in the memory 92. The processor 91 may obtain a water level value corresponding to a given flow rate by using the correlation formula, and may obtain the first amount of water corresponding to the obtained water level value.

That is, the first amount of water may be a predicted total amount of water supplied to the drum 30.

The processor 91 may determine the amount of water (a second amount of water) in the drum 30 based on the detection result of the water level sensor 95 (803).

That is, based on the correlation formula described above, the processor 91 may obtain the second amount of water corresponding to the water level value detected by the water level sensor 95.

The second amount of water may be the current amount of water stored in the drum 30.

The processor 91 may calculate a difference between the first amount of water and the second amount of water (805).

In other words, the processor 91 may determine the amount of water contained in the laundry by calculating the difference between the predicted total amount of water supplied to the drum 30 (the first amount of water) and the current amount of water stored in the drum 30 (the second amount of water).

Thus, “amount of water in laundry=first amount of water-second amount of water.”

The processor 91 may calculate the moisture content ratio of the laundry based on the difference (807).

As described above, the moisture content ratio may be “amount of water in laundry/weight of laundry”. By dividing the determined amount of water by the weight of the laundry, the processor 91 may calculate the moisture content ratio of the laundry.

As such, the washing machine 1 according to the disclosure may calculate the moisture content ratio of the laundry using only the water level sensor 95 and the flow sensor 94, without an additional sensor.

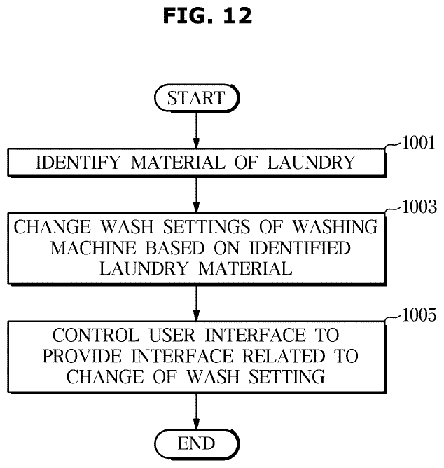

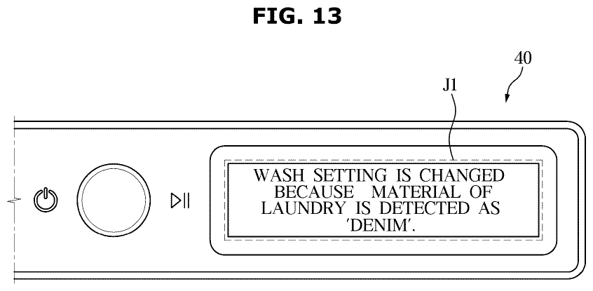

FIG. 12 is a flowchart illustrating operations after identification of laundry material according to an embodiment. FIG. 13 is a diagram illustrating an interface related to change of wash settings according to laundry material identification according to an embodiment.

Once a material of laundry is identified (1001) according to the above-described laundry material identification operation, the processor 91 may change the wash settings of the washing machine 1 based on the identified laundry material (1003).

In other words, the washing machine 1 may change the wash settings from a default wash setting to a wash setting corresponding to the identified laundry material in response to the laundry material being identified.

The wash settings may include a rotation speed of the drum 30, an operation time of a washing process, and the like. The processor 91 may control the driving device 40 such that a rotation speed and/or operation time of the drum 30 varies depending on the identified laundry material.

The processor 91 may control the user interface 15 to provide an interface related to the change of wash setting (1005).

As described above, the information provided via the user interface 15 may include auditory information such as voice, and/or visual information such as display output.

For example, as shown in FIG. 13, a message such as “the wash setting is changed because the laundry material is detected as ‘denim’.” may be displayed, thereby informing a user that washing information has been changed based on the detected laundry material.

According to an embodiment of the disclosure, a washing machine may include: a drum configured to accommodate laundry; a motor configured to rotate the drum; a current sensor configured to detect a current generated by the motor; a memory; and at least one processor configured to identify a material of the laundry by inputting a first current value detected by the current sensor while the drum rotates with the laundry in a dry state, a second current value detected by the current sensor while the drum rotates with the laundry in a wet state, and a moisture content ratio of the laundry into an artificial intelligence (AI) model.

According to the disclosure, a wider range of laundry materials may be more accurately identified by using a moisture content ratio of the laundry.

The washing machine may further include: a flow sensor configured to detect an amount of water supplied to the drum; and a water level sensor configured to detect a water level in the drum. The at least one processor may be configured to calculate the moisture content ratio of the laundry based on a detection result of the flow sensor and a detection result of the water level sensor.

The at least one processor may be configured to determine a first amount of water in the drum based on the detection result of the flow sensor, determine a second amount of water in the drum based on the detection result of the water level sensor, and calculate the moisture content ratio of the laundry based on a difference between the first amount of water and the second amount of water.

The at least one processor may be configured to determine the first amount of water in the drum based on the detection result of the flow sensor according to a flow rate/water level correlation formula stored in the memory.

The at least one processor may be configured to change a wash setting of the washing machine based on the identified material of the laundry.

According to the disclosure, an efficient washing process may be performed by changing a wash setting according to a laundry material.

The at least one processor may be configured to start a washing process according to a default wash setting based on receiving a washing start command, and perform an operation to identify the material of the laundry in response to an elapse of a predetermined period of time after the washing process starts.

The at least one processor may be configured to change the wash setting from the default wash setting to a wash setting corresponding to the identified material in response to the material of the laundry being identified.

The washing machine may further include a user interface, wherein the at least one processor may be configured to control the user interface to provide an interface related to change of the wash setting of the washing machine.

The AI model may be trained based on data associated with the material identified by the AI model using the first current value, the second current value, and the moisture content ratio of the laundry.

The first current value may include an average of current values detected by the current sensor in the dry state of the laundry, and the second current value may include an average and a variance of current values detected by the current sensor in the wet state of the laundry.

According to an embodiment of the disclosure, in a method for controlling a washing machine including a drum configured to accommodate laundry, a motor configured to rotate the drum, and a current sensor configured to detect a current generated by the motor, the method may include: obtaining a first current value detected by the current sensor while the drum rotates with the laundry in a dry state; obtaining a second current value detected by the current sensor while the drum rotates with the laundry in a wet state; calculating a moisture content ratio of the laundry; and identifying a material of the laundry by inputting the first current value, the second current value, and the moisture content ratio into an AI model.

The washing machine may further include: a flow sensor configured to detect an amount of water supplied to the drum; and a water level sensor configured to detect a water level in the drum, wherein the calculating of the moisture content ratio of the laundry may include calculating the moisture content ratio of the laundry based on a detection result of the flow sensor and a detection result of the water level sensor.

The calculating of the moisture content ratio of the laundry may include: determining a first amount of water in the drum based on the detection result of the flow sensor; determining a second amount of water in the drum based on the detection result of the water level sensor; and calculating the moisture content ratio of the laundry based on a difference between the first amount of water and the second amount of water.

The determining of the first amount of water in the drum may include determining the first amount of water in the drum based on the detection result of the flow sensor according to a flow rate/water level correlation formula stored in a memory.

The method may further include changing a wash setting of the washing machine based on the identified material of the laundry.

The method may further include: starting a washing process according to a default wash setting based on receiving a washing start command, and identifying the material of the laundry in response to an elapse of a predetermined period of time after the washing process starts.

The method may further include changing the wash setting from the default wash setting to a wash setting corresponding to the identified material in response to the material of the laundry being identified.

The washing machine may further include a user interface, and the method may further include controlling the user interface to provide an interface related to change of the wash setting of the washing machine.

The AI model may be trained based on data associated with the material identified by the AI model using the first current value, the second current value, and the moisture content ratio of the laundry.

The first current value may include an average of current values detected by the current sensor in the dry state of the laundry, and the second current value may include an average and a variance of current values detected by the current sensor in the wet state of the laundry.

According to an aspect of the disclosure, a wider range of laundry materials may be more accurately identified by using a moisture content ratio of the laundry.

In addition, an efficient washing process may be performed by changing a wash setting according to a laundry material.

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that can be interpreted by a computer. For example, the computer-readable recording medium may be read only memory (ROM), random access memory (RAM), a magnetic tape, a magnetic disc, a flash memory, an optical data storage device, etc.

The computer-readable recording medium may be provided in the form of a non-transitory storage medium. The term ‘non-transitory storage medium’ may refer to a tangible device without including a signal, e.g., electromagnetic waves, and may not distinguish between storing data in the storage medium semi-permanently and temporarily. For example, the ‘non-transitory storage medium’ may include a buffer that temporarily stores data.

In an embodiment of the disclosure, the aforementioned method according to the one or more embodiments of the disclosure may be provided in a computer program product. The computer program product may be a commercial product that may be traded between a seller and a buyer. The computer program product may be distributed in the form of a storage medium (e.g., a compact disc read only memory (CD-ROM)), through an application store (e.g., Play Store™), directly between two user devices (e.g., smart phones), or online (e.g., downloaded or uploaded). In the case of online distribution, at least part of the computer program product (e.g., a downloadable app) may be at least temporarily stored or arbitrarily created in a storage medium that may be readable to a device such as a server of the manufacturer, a server of the application store, or a relay server.

Although the embodiments of the disclosure have been provided for illustrative purposes, the scope of the disclosure is limited to the embodiments of the disclosure. One or more embodiments that may be modified and altered by those skilled in the art without departing from the principles and spirit of the disclosure, the scope of which is defined in the claims, should be construed as falling within the scope of the disclosure.

1. A washing machine, comprising:
a drum configured to accommodate laundry;
a motor configured to rotate the drum;
a current sensor configured to detect a current value corresponding to a current applied to the motor; and
at least one processor configured to:
identify a first current value corresponding to a current value detected by the current sensor while the motor rotates the drum with the laundry in a dry state,
identify a second current value corresponding to a current value detected by the current sensor while the motor rotates the drum with the laundry in a wet state,
determine a moisture content ratio of the laundry based on an amount of water in the laundry and a weight of the laundry, and
input the detected first current value, the detected second current value and the determined moisture content ratio into an artificial intelligence (AI) model to identify a material of the laundry.

2. The washing machine of claim 1, further comprising:
a flow sensor configured to detect an amount of water supplied to the drum; and
a water level sensor configured to detect a water level of water in the drum,
wherein the at least one processor is further configured to:
determine the amount of water in the laundry based on the amount of water supplied to the drum detected by the flow sensor and the water level of water in the drum detected by the water level sensor.

3. The washing machine of claim 2, wherein
the at least one processor is further configured to:
determine a first amount of water in the drum based on the amount of water supplied to the drum detected by the flow sensor,
determine a second amount of water in the drum based on the water level of water in the drum detected by the water level sensor, and
determine the moisture content ratio of the laundry based on a difference between the first amount of water and the second amount of water.

4. The washing machine of claim 3, wherein
the at least one processor is further configured to:
determine the first amount of water in the drum based on the amount of water supplied to the drum detected by the flow sensor according to a flow rate/water level correlation formula stored in a memory.

5. The washing machine of claim 1, wherein
the at least one processor is further configured to:
change a wash setting of the washing machine based on the identified material of the laundry.

6. The washing machine of claim 5, wherein
the at least one processor is further configured to:
start a washing process according to a default wash setting based on receiving a washing start command, and
perform an operation to identify the material of the laundry in response to an elapse of a predetermined period of time after the washing process is started.

7. The washing machine of claim 6, wherein
the at least one processor is further configured to:
change the washing process to a washing process corresponding to the identified material of the laundry in response to the material of the laundry being identified.

8. The washing machine of claim 5, further comprising:
a user interface,
wherein the at least one processor is further configured to:
control the user interface to provide an interface related to changing of the wash setting of the washing machine.

9. The washing machine of claim 1, wherein the AI model is trained based on data associated with materials of laundry, current values corresponding to a current applied to the motor, and moisture content ratios of laundry.

10. The washing machine of claim 1, wherein
the detected first current value includes an average of current values detected by the current sensor and which correspond to currents applied to the motor while the motor rotates the drum with the laundry in the dry state, and
the detected second current value includes an average and a variance of current values detected by the current sensor and which correspond to currents applied to the motor while the motor rotates the drum with the laundry in the wet state.

11. A method for controlling a washing machine including a drum configured to accommodate laundry, a motor configured to rotate the drum, and a current sensor configured to detect a current value corresponding to a current applied to the motor, the method comprising:
identifying a first current value corresponding to a current value detected by the current sensor while the motor rotates the drum with the laundry in a dry state,
identifying a second current value corresponding to a current value detected by the current sensor while the motor rotates the drum with the laundry in a wet state,
determining a moisture content ratio of the laundry based on an amount of water in the laundry and a weight of the laundry, and
inputting the detected first current value, the detected second current value, and the determined moisture content ratio into an artificial intelligence (AI) model to identify a material of the laundry.

12. The method of claim 11, wherein
the washing machine further includes:
a flow sensor configured to detect an amount of water supplied to the drum, and
a water level sensor configured to detect a water level of water in the drum, and
wherein the determining the moisture content ratio of the laundry includes determining the amount of water in the laundry based on the amount of water supplied to the drum detected by the flow sensor and the water level of water in the drum detected by the water level sensor.

13. The method of claim 12, wherein
the determining the moisture content ratio of the laundry includes:
determining a first amount of water in the drum based on the amount of water supplied to the drum detected by the flow sensor,
determining a second amount of water in the drum based on the water level of water in the drum detected by the water level sensor, and
determining the moisture content ratio of the laundry based on a difference between the first amount of water and the second amount of water.

14. The method of claim 13, wherein
the determining of the first amount of water in the drum includes determining the first amount of water in the drum based on the amount of water supplied to the drum detected by the flow sensor according to a flow rate/water level correlation formula stored in a memory.

15. The method of claim 11, further comprising:
changing a wash setting of the washing machine based on the identified material of the laundry.
